(19) United States
(12) Patent Application Publication
(10) Pub. No.: US 2025/0275548 A1
(43) Pub. Date: Sep. 4, 2025

(54) POTATO-BASED CHEESE ANALOGUE

(71) Applicant: Coöperatie Koninklijke Cosun U.A., Breda (NL)

(72) Inventors: Christiaan Leonardus Henricus Pingen, Oostrum (NL); Charles Hendricus Johannes Meijerink, Warffum (NL); Cornelis Adriaan Johanna Maria Meeuwissen, Dinteloord (NL); Tim Eelko Veerman, Dinteloord (NL); Antonius Lucien Adrianus Maria Kemmeren, Dinteloord (NL); Yolanda Llamas Bogers, Dinteloord (NL); Aimée Beatrice Verkade, Dinteloord (NL)

(73) Assignee: Coöperatie Koninklijke Cosun U.A., Breda (NL)

(21) Appl. No.: 18/262,733

(22) PCT Filed: Jan. 26, 2022
(86) PCT No.: PCT/EP2022/051722

§ 371 Date: Jul. 25, 2023

(30) Foreign Application Priority Data
Jan. 27, 2021 (EP) 21153836.8

(51) Int. Cl. A23C 20/02; A23L 19/12

(52) U.S. Cl. CPC A23C 20/02; A23L 19/12

(57) ABSTRACT

The invention relates to a potato-based cheese analogue and to a method for its manufacture, said potato-based cheese analogue consisting of a mixture of 100 parts (by weight) of a composition (A) and 0-10 parts (by weight) of a composition (B):
wherein composition (A) consists of between 20.7 and 30 wt. % of dry matter and between 70 and 79.3 wt. % of water, based on the weight of composition (A), wherein the dry matter is potato-based material,
   wherein the dry matter comprises between 3 and 9.6 wt. % of potato tuber cell wall material and potato tuber intercellular substances, based on the weight of the dry matter, and
   wherein the dry matter comprises more than 72 wt. % of potato tuber starch, preferably more than 75 wt. %, based on the weight of the dry matter;
wherein composition (B) consists of one or more non-potato-based, preferably non-aqueous, further ingredients, with the proviso that the one or more non-potato-based further ingredients do not comprise hydrolysed starch, carrot, egg yolk, flour, casein or combinations thereof,
   wherein the potato-based cheese analogue has a hardness at 20° C. characterized by a Peak Positive Force of at least 6 kg and a Positive Area of at least 75 kg·s, and wherein the viscosity of the potato-based cheese analogue at 80° C. and at a shear rate of 1 s⁻¹ is less than 400 Pa·s.

### FIELD OF THE INVENTION

The present invention relates to potato-based cheese analogues and to methods for its manufacture. The present invention further relates to meals comprising said potato-based cheese analogues or comprising the potato-based cheese analogues obtained or obtainable via said methods.

### BACKGROUND OF THE INVENTION

Cheese is a dairy product derived from milk that is produced in a wide range of flavours, textures, and forms by coagulation of the milk protein casein. It comprises proteins and fat from milk, usually the milk of cows, buffalo, goats or sheep. Many cheeses have a gel-like protein matrix that is broken down by heat. When the temperature is sufficiently high, sufficient protein bonds are broken and the cheese turns from a solid to a viscous liquid, i.e. it melts. Many food dishes, especially oven dishes such as pizza or lasagne, rely on the melt-flow behaviour of cheese to provide a distinct mouthfeel and consumer experience.

Since cheese is derived from an animal product, its long-term sustainability is a matter of concern. Increased demand for animal-based products is expected to have a negative environmental impact and to place increased pressure on the world's resources. Additionally, there are other consumer concerns related to cheese, such as lactose intolerance or risk of bacterial infection, such as infection by listeria bacteria. Significant research effort is thus being dedicated to developing plant-based products which could at least partly substitute cheese, especially which could at least partly substitute so-called ‘commodity cheeses’ or ‘processed cheeses’ which are used for fresh or frozen oven dishes, such as pizza or lasagna.

Many different cheese substitutes or analogues have been developed, employing a variety of raw materials.

J. S. Mounsey et al., Eur. Food Res. Technol., 226 (2008), pp 1039-1046, concerns a study of the influence of replacing part of casein in imitation cheese products with pre-gelatinized starch. An imitation cheese not comprising pre-gelatinized starch was used as a control. The control imitation cheese comprised 48 wt. % water, 24.5 wt. % rennet casein and 26 wt. % vegetable fat. In the modified imitation cheeses, 15 wt. % of the rennet casein (3 wt. % of the total product) was replaced with either pre-gelatinized maize, waxy-maize, wheat potato or rice starch. All imitation cheeses were prepared by blending all ingredients in a twin-screw cooker at 35° C., followed by heating to 78° C. using direct steam. After 5 minutes of mixing at 100 rpm, the product were packed and cooled to 4° C. Accordingly, these imitation cheeses still contain considerable amounts of milk-based ingredients.

A vegan cheese is known that is prepared by mixing as main ingredients potatoes (2 cups), carrots (1 cup), water (½ cup), nutritional yeast flakes (½ cup) and olive oil (⅓ cup) in a blender. Since water is added, carrot contains a lot of water and since carrot does not contain starch that can bind water, the vegan cheese is not a firm product that can be sliced or grated. Indeed, the product is a vegan cheese sauce.

WO2014/110540A1 discloses non-dairy cheese replicas based on enzymatically treated almond and macadamia nut milk. US2017/0020156A1 discloses vegan cheese products based on pea protein and tapioca starch. EP3302079A1 discloses a cheese analogue product comprising chemically modified corn or potato starches.

EP3213638A1 discloses a cheese analogue comprising potato tuber starch, native potato protein and a fat component. The cheese analogue is prepared by adding isolated root starch or tuber starch, isolated native potato protein, fat and water. The resulting mixture is heated to a temperature of between 7° and 90° C., cooled until a solid is formed and ripened for at least 1 day. In Example 1 of EP3213638A1, the preparation of a standard recipe is described comprising mixing of 55.8 wt. % water, 17 wt. % waxy potato starch (>99 wt. % amylopectin), 2 wt. % native potato protein, 0.2 wt. % salt and 25 wt. % oil. These ingredients are mixed at 37° C. Subsequently, the mass is heated to 85° C. wt. % under slow stirring causing gelatinization of the starch. The resulting product is then stored at 4° C.

The cheese substitutes, cheese analogues or imitation cheeses known in the art are generally complex to produce and often require substantial amounts of non-potato-based ingredients, expensive or chemically modified ingredients, such as oils, fats, isolated proteins, isolated starches and/or derivatized starches. In addition, known cheese substitutes, cheese analogues or imitation cheeses may not have satisfactory properties, such as mouthfeel, firmness, slicability, gratability, melt-flow behaviour or combinations thereof.

In view of its large availability and long cultivation history, potato tubers have always been an attractive food source. Potato tubers are commonly consumed as a whole (although generally after cooking), and are employed for the production of processed foods such as savoury snacks. In spite of this, there are no potato-based products available which contain all ingredients of the potato tuber and which could qualify as a substitute for commodity cheeses.

It is an object of the present invention to provide novel potato-based cheese analogues that have distinctive properties, which can be used as a commodity cheese substitutes and which may be produced in a simplified way from whole potato and/or in a sustainable and economically viable manner.

### SUMMARY OF THE INVENTION

The inventors have unexpectedly established that the above objects can be met by performing a process wherein cooked potato tuber material, more in particular cooked potato tuber material containing all the ingredients of whole potatoes, is subjected to a high-shear refining treatment wherein a minimum amount of shear is applied and wherein the thus obtained refined potato-tuber-based material is cooled to a temperature of 15° C. or less under mixing conditions. Without this minimum amount of shear and without the use of mixing during cooling of the refined potato-tuber-based material, the resulting product does not qualify as a potato-based cheese analogue because it does not exhibit the required viscosity at 80° C. and hardness at 20° C.

When the process according to the invention is applied, a potato-based cheese analogue having the required low viscosity at 80° C. and sufficient hardness at 20° C. can be obtained.

Accordingly, in a first aspect the invention provides a potato-based cheese analogue consisting of a mixture of 100 parts (by weight) of a composition (A) and 0-10 parts (by weight) of a composition (B):
wherein composition (A) consists of between 20.7 and 30 wt. % of dry matter and between 70 and 79.3 wt. % of water, based on the weight of composition (A), wherein the dry matter is potato-based material,
   wherein the dry matter comprises between 3 and 9.6 wt. % of potato tuber cell wall material and potato tuber intercellular substances, based on the weight of the dry matter, and
   wherein the dry matter comprises more than 72 wt. % of potato tuber starch, preferably more than 75 wt. %, based on the weight of the dry matter;
wherein composition (B) consists of one or more non-potato-based, preferably non-aqueous, further ingredients, with the proviso that the one or more non-potato-based further ingredients do not comprise hydrolysed starch, carrot, egg yolk, flour, casein or combinations thereof,
   wherein the potato-based cheese analogue has a hardness at 20° C., as determined with a texture analyzer on a sample with a size of 3.5×3.5×4 cm (l×w×h) by performing a 20 mm compression at a speed of 1 mm/s with a 30 kg load cell and a 30 g trigger force, characterized by a Peak Positive Force of at least 6 kg and a Positive Area of at least 75 kg·s, and wherein the viscosity of the potato-based cheese analogue at 80° C. and at a shear rate of 1 s⁻¹, as measured with a rheometer with a starch cell geometry, is less than 400 Pa·s.

This potato-based cheese analogue differs at least from the cheese analogue disclosed in EP3213638A1 in that it comprises potato tuber cell wall material and potato tuber intercellular substances.

In a second aspect, the invention concerns a method for producing a potato-based cheese analogue as defined herein, comprising the steps of:
a) providing cooked potato tuber material comprising between 70 and 79.3 wt. % of water, based on the weight of the cooked potato tuber material, wherein said cooked potato tuber material is selected from the group consisting of:
   cooked potato tuber material comprising all ingredients of potato tuber;
   cooked and mashed potato tuber material comprising all ingredients of potato tuber;
   peeled and cooked potato tuber material comprising all ingredients of potato tuber excluding the skin;
   peeled, cooked and mashed potato tuber material comprising all ingredients of potato tuber excluding the skin;
b) subjecting the cooked potato tuber material of step (a) to a high-shear refining treatment resulting in a refined potato-tuber-based material comprising between 70 and 79.3 wt. % of water, based on the weight of the refined potato-tuber-based material, wherein high-shear refining treatment refers to subjecting the potato-tuber-based material to shear forces in a rotor-stator mixer, wherein the distance between the stator and the tips of the rotor is d [m], wherein the rotational speed of the tips of the rotor is v [m·s⁻¹] and wherein v/d is higher than 6.4·10⁴ s⁻¹;
c) cooling the refined potato-tuber-based material obtained in step (b) to a temperature of 15° C. or less under mixing conditions, preferably 10° C. or less, to provide a potato-tuber-based dough; and
d) solidifying the potato-tuber-based dough obtained in step (c) to obtain the potato-based cheese analogue,
wherein 0-10 parts (by weight) of the one or more of the non-potato-based, preferably non-aqueous, further ingredients are added:
   to the cooked potato tuber material provided in step (a), before step (b), per 100 parts (by weight) of the cooked potato tuber material provided in step (a); or
   to the refined potato-tuber-based material provided in step (b), before and/or during step (c), per 100 parts (by weight) of the cooked potato tuber material provided in step (a); or
   partly to the cooked potato tuber material provided in step (a), before step (b), and partly to the refined potato-tuber-based material provided in step (b), before and/or during step (c), per 100 parts (by weight) of the cooked potato tuber material provided in step (a).

In a third aspect, the invention provides a potato-based cheese analogue obtainable by the method as described herein.

In a fourth aspect, the invention provides a meal comprising the potato-based cheese analogue as defined herein or the potato-based cheese analogue obtained by or obtainable by the method as described herein.

### BRIEF DESCRIPTION OF THE FIGURES

FIGS. 1-6 depict flow schemes of different embodiments of the methods for producing a potato-based cheese analogue as defined herein.

FIG. 7 depicts an example of a compression diagram (mass [or force] versus time) obtained with a texture analyzer.

FIGS. 8-11 depict viscosity versus shear rate profiles (at 80° C.) of potato-based products obtained for different potato varieties using different amounts of shear during high-shear refining.

FIGS. 12-14 present overviews of the viscosity data, peak positive force data and positive area data, respectively, for all potato varieties tested.

### DETAILED DESCRIPTION

### Potato-Based Cheese Analogue

In a first aspect, the invention provides a potato-based cheese analogue consisting of a mixture of 100 parts (by weight) of a composition (A) and 0-10 parts (by weight) of a composition (B):
wherein composition (A) consists of between 20.7 and 30 wt. % of dry matter and between 70 and 79.3 wt. % of water, based on the weight of composition (A), wherein the dry matter is potato-based material,
   wherein the dry matter comprises between 3 and 9.6 wt. % of potato tuber cell wall material and potato tuber intercellular substances, based on the weight of the dry matter, and
   wherein the dry matter comprises more than 72 wt. % of potato tuber starch, preferably more than 75 wt. %, based on the weight of the dry matter;
wherein composition (B) consists of one or more non-potato-based, preferably non-aqueous, further ingredients, with the proviso that the one or more non-potato-based further ingredients do not comprise hydrolysed starch, carrot, egg yolk, flour, casein or combinations thereof,
   wherein the potato-based cheese analogue has a hardness at 20° C., as determined with a texture analyzer on a sample with a size of 3.5×3.5×4 cm (l×w×h) by performing a 20 mm compression at a speed of 1 mm/s with a 30 kg load cell and a 30 g trigger force, characterized by a Peak Positive Force of at least 6 kg and a Positive Area of at least 75 kg·s, and wherein the viscosity of the potato-based cheese analogue at 80° C. and at a shear rate of 1 s⁻¹, as measured with a rheometer with a starch cell geometry, is less than 400 Pa·s.

When reference is made to a viscosity of the potato tuber starch in the potato-based cheese analogue, this viscosity has been measured using the analytical protocol as defined in the Examples. Likewise, when reference is made to a hardness of the potato tuber starch in the potato-based cheese analogue, this hardness has been measured using the analytical protocol as defined in the Examples.

The term ‘potato-based cheese analogue’ in the context of the present invention refers to a product that is obtained by processing potato tubers, that contains all the ingredients of potato tuber or all the ingredients of potato tuber minus the skin, optionally supplemented with a small amount of non-potato-based further and non-aqueous ingredients, and that has cheese-like properties such as hardness, gratability and slicability at low temperature and meltability or flowability at increased temperature. The product is a potato-based cheese analogue and not a real cheese because it does not contain the typical milk-based ingredients of real cheese. The potato-based cheese analogue according to the invention comprises between 90.91 (100 parts by weight on 110 parts by weight) and 100 wt. % of potato-tuber material and water.

In a preferred embodiment, the potato-based material in composition (A) is material obtained from whole potatoes, optionally peeled whole potatoes, that have only been processed by applying heat, shear and/or pressure.

The potato-based cheese analogue of the present invention can thus be distinguished from for example other potato-material-containing cheese analogues further comprising substantial amounts of carrot or milk-derived ingredients because it comprises between 90.91 and 100 wt. % of potato-tuber material and water. Moreover, the potato-based cheese analogue of the present invention can be distinguished from for example other potato-material-containing cheese analogues that are produced by combining pure ingredients that have first been isolated from potato tubers, such as for example the vegan cheese analogue of EP3213638A1, because the potato-based cheese analogue of the present invention contains all the ingredients of potato tuber (or all the ingredients of potato tuber minus the skin), such as potato tuber cell wall material and potato tuber intercellular substances.

### Potato-Based Material

In a preferred embodiment, the dry matter in composition (A) comprises between 3 and 8.5 wt. %, based on the weight of the dry matter, of potato tuber cell wall material and potato tuber intercellular substances, such as between 3 and 8 wt. %, between 3 and 7.5 wt. %, between 3 and 7 wt. %, between 3 and 6.5 wt. % or between 3 and 6 wt. %. In another preferred embodiment, the dry matter in composition (A) comprises between 3.5 and 9.6 wt. %, based on the weight of the dry matter, of potato tuber cell wall material and potato tuber intercellular substances, such as between 4 and 9.6 wt. %, between 4.5 and 9.6 wt. %, between 5 and 9.6 wt. %, between 5.5 and 9.6 wt. % or between 6 and 9.6 wt. %.

As will be appreciated by those skilled in the art, the composition of the potato-based material in composition (A) is, to a large extent, determined by the potato variety that has been used to prepare the potato-based cheese analogue, since different varieties may have different dry matter contents and may comprise amongst other things different amounts of starch, and within the starch component different amounts of amylose and amylopectin. Species of potato tuber that can be used in the present invention include Solanum tuberosum or Irish potato.

Preferred varieties include Fontane, Aveka, Novano, Alter, Saprodi, Axion, Achilles, Avarna and Sassy. Most preferably, the potato-based material in composition (A) originates from potato tubers chosen from Solanum tuberosum, varieties Fontane and Novano.

In another preferred embodiment, the potato-based material in composition (A) originates from potatoes having an underwater weight of between 380 and 490 g, such as between 400 and 490 g, between 420 and 490 g, between 430 and 490 g, or between 435 and 480 g. In a very preferred embodiment, the potato-based material in composition (A) originates from potatoes chosen from Solanum tuberosum, varieties Fontane and Novano, having an underwater weight of between 380 and 490 g, such as between 400 and 490 g, between 420 and 490 g, between 430 and 490 g, or between 435 and 480 g.

In another preferred embodiment, composition (A) consists of between 21 and 30 wt. % of dry matter and between 70 and 79 wt. % of water, based on the weight of composition (A), wherein the dry matter is potato-based material. In yet another preferred embodiment, composition (A) consists of between 22 and 30 wt. % of dry matter and between 70 and 78 wt. % of water, based on the weight of composition (A), wherein the dry matter is potato-based material. In still another preferred embodiment, composition (A) consists of between 23 and 30 wt. % of dry matter and between 70 and 77 wt. % of water, based on the weight of composition (A), wherein the dry matter is potato-based material. In still another preferred embodiment, composition (A) consists of between 23 and 28 wt. % of dry matter and between 72 and 77 wt. % of water, based on the weight of composition (A), wherein the dry matter is potato-based material. In still another preferred embodiment, composition (A) consists of between 23 and 26 wt. % of dry matter and between 74 and 77 wt. % of water, based on the weight of composition (A), wherein the dry matter is potato-based material.

In a preferred embodiment, the potato tuber cell wall material and potato tuber intercellular substances in composition (A) of the potato-based cheese analogue are non-starch polysaccharides chosen from the group consisting of cellulose, hemicellulose, pentosans and pectic substances.

In a preferred embodiment, the dry matter in composition (A) comprises between 0.15 and 0.55 wt. %, based on the weight of the dry matter, of potato tuber lipids, such as between 0.15 and 0.50 wt. %, between 0.15 and 0.47 wt. %, between 0.15 and 0.44 wt. %, between 0.15 and 0.42 wt. % or between 0.15 and 0.40 wt. %. In another preferred embodiment, the dry matter in composition (A) comprises between 0.19 and 0.55 wt. %, based on the weight of the dry matter, of potato tuber lipids, such as between 0.22 and 0.55 wt. %, between 0.25 and 0.55 wt. %, between 0.27 and 0.55 wt. %, between 0.29 and 0.55 wt. % or between 0.31 and 0.55 wt. %.

### Further Ingredients

The one or more further ingredients are non-potato-based further ingredients, which means in the context of the present invention that these one or more further ingredients do not comprise any one of potato, ingredients isolated form potato, ingredients obtained by processing potato and ingredients obtained by processing ingredients isolated form potato.

In a very preferred embodiment, the one or more non-potato-based further ingredients are non-aqueous, which means that water as such is not one of the one or more non-potato-based further ingredients. This does however not mean that the one or more non-potato-based further ingredients cannot contain water. The one or more non-potato-based further ingredients preferably together have a water content of less than 60 wt. %, based on the total weight of non-potato-based further ingredients, preferably less than 50 wt. %, even more preferably less than 40 wt. %, such as less than 30 wt. %, less than 20 wt. %, less than 10 wt. %, less than 5 wt. % and less than 2 wt. %.

In a preferred embodiment, the one or more non-potato-based further ingredients do not comprise hydrolysed starch, milk, milk-derived ingredients, casein, carrot, egg yolk, corn starch, flour, yeast or combinations thereof.

In a very preferred embodiment, the one or more non-potato-based further ingredients are chosen from the group consisting of fats, oils, fatty acids, phospholipids, cholesterol, proteins, minerals, (food grade) colourants, preservatives, salt, flavouring agents, vitamins and seasoning, more preferably from the group consisting of (food grade) colourants, preservatives, salt, flavouring agents and seasoning.

In an embodiment, the fats, oils, fatty acids, phospholipids, cholesterol and combinations thereof are preferably chosen from the group consisting of sunflower oil, canola oil, olive oil, palm oil, coconut fat, cocoa fat, soybean oil, rapeseed oil, peanut oil, cotton seed oil, corn oil, linseed oil, rice bran oil, safflower oil, sesame oil, acai palm oil, palm kernel, cottonseed oil, hazelnut oil and combinations thereof, more preferably from the group consisting of rapeseed oil, sunflower oil, palm oil, corn oil, soybean oil and combinations thereof, most preferably from the group consisting of sunflower oil, rapeseed oil and combinations thereof.

In a very preferred embodiment, the one or more non-potato-based further ingredients do not comprise any one of fat, oil, fatty acids, phospholipids and cholesterol.

Suitable proteins include plant-derived proteins such as soybean protein, pea protein, bean protein, lupin protein and potato protein.

Suitable minerals include macro-minerals, such as calcium, phosphorus, magnesium, sodium, potassium, chloride and sulfur, and trace minerals, such as iron, manganese, copper, iodine, zinc, cobalt, fluoride and selenium.

Suitable colourants include annatto (a mix of bixine and norbixine as obtained from Bixa orrelana) and β-carotene.

Suitable flavouring agents include cheese flavour powders, lactic acid and citric acid. Preferred flavouring agents are cheese flavour powders, such as parmesan cheese flavour powder.

Suitable preservatives include organic carboxylic acids or salts thereof, including potassium sorbate, lactic acid, citric acid, acetic acid and combinations thereof. Hence, in a preferred embodiment, the potato-based cheese analogue comprises more than 0.15 wt. % of a preservative, preferably more than 0.15 wt. % of a preservative selected from potassium sorbate, lactic acid, citric acid, acetic acid and combinations thereof.

Suitable vitamins include vitamin A, vitamin B1, vitamin B2, vitamin B3, vitamin B5, vitamin B6, vitamin B7, vitamin B9, vitamin B12, vitamin C, vitamin D, vitamin E and vitamin K.

In a preferred embodiment, the potato-based cheese analogue consists of a mixture of 100 parts (by weight) of composition (A) and 0-8 parts (by weight) of composition (B), more preferably of a mixture of 100 parts (by weight) of composition (A) and 0-5 parts (by weight) of composition (B), such as 0.1-4.5 parts (by weight) of composition (B) or 0.5-4 parts (by weight) of composition (B).

In a preferred embodiment, the one or more non-potato-based further ingredients of composition (B) are homogeneously distributed, across composition (A).

### Cheese-Like Properties

The potato-based cheese analogue as defined herein can be manufactured by gelatinizing potato tubers, e.g. by cooking them, and by subjecting the resulting gelatinized potato tuber material to high shear to completely disrupt the cells and to free the starch molecules (amylose and amylopectin).

As exemplified in the appended examples, the inventors have established that the amount of shear applied during the process to prepare a refined potato-tuber-based material and the use of mixing or not during cooling of the refined potato-tuber-based material determine whether the product has good cheese-like properties such as hardness at low temperature and good flowability at high temperature. In other words, the amount of shear applied during the process to prepare a refined potato-tuber-based material and the use of mixing or not during cooling of the refined potato-tuber-based material determine whether the product obtained can qualify as a potato-based cheese analogue or not. The hardness at 20° C. and the viscosity at 80° C. and at a shear rate of 1 s⁻¹ as defined herein provide the potato-based product with cheese-like properties.

In a very preferred embodiment, the potato-based cheese analogues according to the invention exhibit shear-thinning behaviour, more preferably they exhibit shear-thinning behaviour at a temperature of 80° C. Shear-thinning behaviour is an advantageous property during the production of the potato-based cheese analogues since it improves the mixing behaviour in step (c) of cooling the refined potato-tuber-based material.

In a preferred embodiment, the potato-based cheese analogue has a viscosity at 80° C. and at a shear rate of 1 s⁻¹, as measured with a rheometer with a starch cell geometry, of at least 100 Pa·s, more preferably of at least 125 Pa·s, even more preferably of at least 150 Pa·s

In a preferred embodiment, the potato-based cheese analogue has:
a hardness at 20° C., as determined with a texture analyzer on a sample with a size of 3.5×3.5×4 cm (l×w×h) by performing a 20 mm compression at a speed of 1 mm/s with a 30 kg load cell and a 30 g trigger force, characterized by a Peak Positive Force of at least 7 kg, more preferably of at least 8 kg, and by a Positive Area of at least 75 kg·s; and
a viscosity at 80° C. and at a shear rate of 1 s⁻¹, as measured with a rheometer with a starch cell geometry, of less than 360 Pa·s, and preferably of at least 100 Pa·s, more preferably of at least 125 Pa·s, even more preferably of at least 150 Pa·s.

In another preferred embodiment, the potato-based cheese analogue has:
a hardness at 20° C., as determined with a texture analyzer on a sample with a size of 3.5×3.5×4 cm (l×w×h) by performing a 20 mm compression at a speed of 1 mm/s with a 30 kg load cell and a 30 g trigger force, characterized by a Peak Positive Force of at least 13 kg and by a Positive Area of at least 140 kg·s, more preferably of at least 150 kg·s; and
a viscosity at 80° C. and at a shear rate of 1 s⁻¹, as measured with a rheometer with a starch cell geometry, of less than 400 Pa·s, and preferably of at least 100 Pa·s, more preferably of at least 125 Pa·s, even more preferably of at least 150 Pa·s.

In another preferred embodiment, the potato-based cheese analogue has:
a hardness at 20° C., as determined with a texture analyzer on a sample with a size of 3.5×3.5×4 cm (l×w×h) by performing a 20 mm compression at a speed of 1 mm/s with a 30 kg load cell and a 30 g trigger force, characterized by a Peak Positive Force of at least 14 kg and by a Positive Area of at least 150 kg·s, more preferably of at least 155 kg·s; and
a viscosity at 80° C. and at a shear rate of 1 s⁻¹, as measured with a rheometer with a starch cell geometry, of less than 360 Pa·s, and preferably of at least 100 Pa·s, more preferably of at least 125 Pa·s, even more preferably of at least 150 Pa·s, yet more preferably of at least 200 Pa·s.

In yet another preferred embodiment, the potato-based cheese analogue has:
a hardness at 20° C., as determined with a texture analyzer on a sample with a size of 3.5×3.5×4 cm (l×w×h) by performing a 20 mm compression at a speed of 1 mm/s with a 30 kg load cell and a 30 g trigger force, characterized by a Peak Positive Force of at least 14 kg and by a Positive Area of at least 160 kg·s; and
a viscosity at 80° C. and at a shear rate of 1 s⁻¹, as measured with a rheometer with a starch cell geometry, of less than 350 Pa·s, and preferably of at least 100 Pa·s, more preferably of at least 125 Pa·s, even more preferably of at least 150 Pa·s, yet more preferably of at least 200 Pa·s.

In a preferred embodiment, the potato tuber starch in the potato-based cheese analogue as defined herein comprises amylose and amylopectin, preferably in a weight ratio of amylose:amylopectin of 10:90 or higher, more preferably 15:85 or higher, even more preferably 17:83 or higher. In another preferred embodiment, the potato tuber starch in the potato-based cheese analogue as defined herein comprises 10-25 wt. % amylose and 75-90 wt. % amylopectin, more preferably 15-20 wt. % amylose and 80-85 wt. % amylopectin.

### Method for Producing a Potato-Based Cheese Analogue

In a second aspect, the invention concerns a method for producing a potato-based cheese analogue as defined hereinbefore, comprising the steps of:
a) providing cooked potato tuber material comprising between 70 and 79.3 wt. % of water, based on the weight of the cooked potato tuber material, wherein said cooked potato tuber material is selected from the group consisting of:
   cooked potato tuber material comprising all ingredients of potato tuber;
   cooked and mashed potato tuber material comprising all ingredients of potato tuber;
   peeled and cooked potato tuber material comprising all ingredients of potato tuber excluding the skin;
   peeled, cooked, mashed and optionally screened potato tuber material comprising all ingredients of potato tuber excluding the skin;
b) subjecting the cooked potato tuber material of step (a) to a high-shear refining treatment resulting in a refined potato-tuber-based material comprising between 70 and 79.3 wt. % of water, based on the weight of the refined potato-tuber-based material, wherein high-shear refining treatment refers to subjecting the potato-tuber-based material to shear forces in a rotor-stator mixer, wherein the distance between the stator and the tips of the rotor is d [m], wherein the rotational speed of the tips of the rotor is v [m·s⁻¹] and wherein v/d is higher than 6.4·10⁴ s⁻¹;
c) cooling the refined potato-tuber-based material obtained in step (b) to a temperature of 15° C. or less under mixing conditions, preferably 10° C. or less, to provide a potato-tuber-based dough; and
d) solidifying the potato-tuber-based dough obtained in step (c) to obtain the potato-based cheese analogue,
wherein 0-10 parts (by weight) of the one or more non-potato-based, preferably non-aqueous, further ingredients as defined hereinbefore are added:
   to the cooked potato tuber material provided in step (a), before step (b), per 100 parts (by weight) of the cooked potato tuber material provided in step (a); or
   to the refined potato-tuber-based material provided in step (b), before and/or during step (c), per 100 parts (by weight) of the cooked potato tuber material provided in step (a); or
   partly to the cooked potato tuber material provided in step (a), before step (b), and partly to the refined potato-tuber-based material provided in step (b), before and/or during step (c), per 100 parts (by weight) of the cooked potato tuber material provided in step (a).

In step (a) of the method, cooked potato tuber material comprising between 70 and 79.3 wt. % of water, based on the weight of the cooked potato tuber material, is provided.

In a preferred embodiment, cooked potato tuber material comprising between 70 and 79 wt. % of water, based on the weight of the cooked potato tuber material, is provided in step (a) of the method. In another preferred embodiment, cooked potato tuber material comprising between 70 and 78 wt. % of water, based on the weight of the cooked potato tuber material, is provided in step (a) of the method. In yet another preferred embodiment, cooked potato tuber material comprising between 70 and 77 wt. % of water, based on the weight of the cooked potato tuber material, is provided in step (a) of the method. In still another preferred embodiment, cooked potato tuber material comprising between 72 and 77 wt. % of water, based on the weight of the cooked potato tuber material, is provided in step (a) of the method. In still another preferred embodiment, cooked potato tuber material comprising between 74 and 77 wt. % of water, based on the weight of the cooked potato tuber material, is provided in step (a) of the method.

The dry matter content of potatoes can roughly vary between 13.1 and 36.8 wt. %, based on the weight of the raw and uncooked potatoes (see G. Lisińska and W. Leszczyński, Potato Science and Technology, Elsevier Applied Science, 1989, page 17, Table 2.1). If the dry matter content of the potatoes that are to be used to provide the cooked potato tuber material in step (a) of the method is less than the minimum value indicated in step (a), the dry matter content needs to be increased to at least said minimum value before step (b). This can for example be accomplished by adding to the cooked potato tubers, cooked and dehydrated potato mass, such as potato flakes and or granules. Potato flakes and granules have been cooked (and subsequently dried). Hence, potato flakes and granules qualify as cooked (and gelatinized) potato tuber material. Cooking potato tubers with for example a dry matter content of 20.7 wt. % or higher in water or with steam may, even after separating off some water or steam, result in cooked potato tuber material with a dry matter content of less than 20.7 wt. %. This can also be compensated by adding cooked and dehydrated potato mass, such as potato flakes and/or granules.

Accordingly, in a preferred embodiment, the method as defined hereinbefore comprises the following steps prior to step (a):
i) providing intact washed raw potato tubers;
ii) optionally peeling the intact washed raw potato tubers of step (i);
iii) optionally slicing the intact washed raw potato tubers of step (i) or the peeled raw potato tubers of step (ii);
iv) cooking the intact washed raw potato tubers of step (i) or the sliced raw potato tubers of step (iii) to obtain cooked potato tuber material comprising all ingredients of potato tuber, or cooking the washed and peeled raw potato tubers of step (ii) or the washed, peeled and sliced raw potato tubers of step (iii) to obtain peeled and cooked potato tuber material comprising all ingredients of potato tuber excluding the skin;
v) optionally mashing the cooked potato tuber material comprising all ingredients of potato tuber obtained in step (iv) to obtain cooked and mashed potato tuber material comprising all ingredients of potato tuber, or optionally mashing the peeled and cooked potato tuber material comprising all ingredients of potato tuber excluding the skin obtained in step (iv) to obtain cooked and mashed potato tuber material comprising all ingredients of potato tuber excluding the skin; and
vi) if the cooked potato tuber material comprising all ingredients of potato tuber or the cooked potato tuber material comprising all ingredients of potato tuber excluding the skin obtained in step (iv) or (v) comprises an amount of water that is different from between 70 and 79.3 wt. %, based on the total weight of the cooked potato tuber material, adjusting said amount of water to between 70 and 79.3 wt. %, preferably by adding cooked and dehydrated potato mass.

The intact washed raw potato tubers provided in step (i) advantageously include species such as Solanum tuberosum or Irish potato. Preferred varieties include Fontane, Aveka, Novano, Alter, Saprodi, Axion, Achilles, Avarna and Sassy. Most preferably, the potato tubers are chosen from Solanum tuberosum, varieties Fontane and Novano.

In another preferred embodiment, the intact washed raw potato tubers provided in step (i) have an underwater weight of between 380 and 490 g, such as between 400 and 490 g, between 420 and 490 g, between 430 and 490 g, or between 435 and 480 g. In a very preferred embodiment, the intact washed raw potato tubers provided in step (i) are chosen from Solanum tuberosum, varieties Fontane and Novano, having an underwater weight of between 380 and 490 g, such as between 400 and 490 g, between 420 and 490 g, between 430 and 490 g, or between 435 and 480 g.

The intact washed raw potato tubers provided in step (i) are completely raw, i.e. they have not been blanched or submitted to other heating steps wherein the temperature of the potato tubers exceeds more than 30° C.

In an embodiment, peeling step (ii) is performed and peeling is followed by washing off the (leftovers of the) peels/skins.

In a preferred embodiment, slicing step (iii) is performed. A french-fry cut, cube cut or any other method for dividing the potatoes into smaller pieces can be used to provide sliced raw potato tubers. In embodiments of the invention the slices have a major dimension of less than 5 cm, less than 3 cm or less than 1 cm.

In accordance with the invention, step (iv) comprises cooking the raw potato tubers such that the starch becomes completely gelatinized. In an embodiment, step (iv) comprises cooking the raw potato tubers to a core temperature of more than 85° C., preferably to a core temperature of more than 90° C., more preferably to a core temperature of more than 95° C. In a preferred embodiment, step (iv) employs a cooking method employing water, such as exposing the potato tubers to steam. It is within the skills of the artisan to adjust cooking time and temperature to obtain complete gelatinization of the starch.

In a preferred embodiment, mashing step (v) is performed. It will be understood by the skilled person that mashing the cooked potato tuber material before the high-shear refining treatment of step (b) may facilitate processing, e.g. by improving pumpability.

In a preferred embodiment, mashing is followed by screening the cooked and mashed potato tuber material in step (v). The term ‘screening’ in the context of the present invention refers to pressing the cooked and mashed potato tuber material over a screen such that potato peels/skins and other unwanted side-products remain on the screen. Screening following mashing the cooked potato tuber material results in a potato-based cheese analogue which has a more attractive visual appearance because the screening step allows for the removal of residual dirt and potato peels.

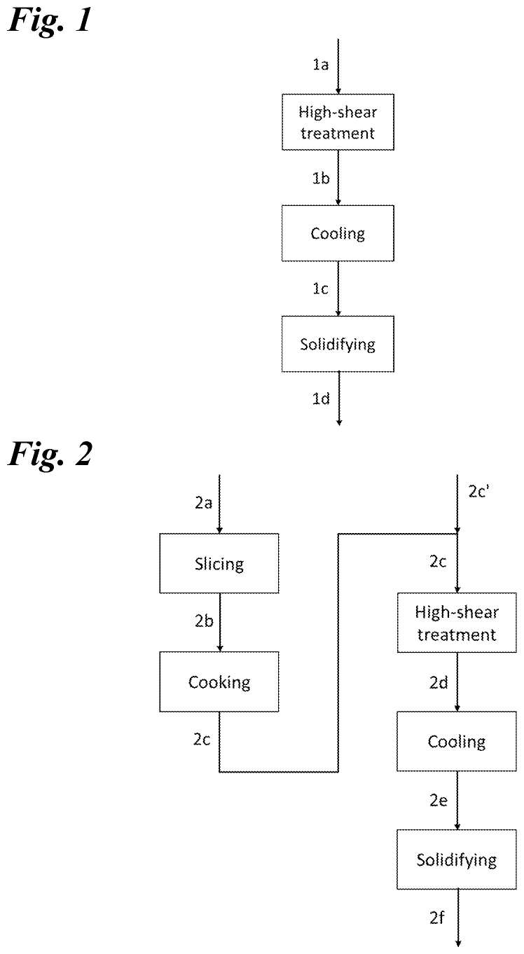

FIG. 1 depicts an embodiment of the method in accordance with the invention comprising providing cooked potato tuber material 1a comprising all ingredients of the potato tuber or all ingredients of the potato tuber excluding the skin [according to step (a)], subjecting the cooked potato tuber material to high-shear refining treatment [according to step (b)] resulting in a refined potato-tuber-based material 1b, which is subjected to a cooling step under mixing conditions [according to step (c)] resulting in a potato-tuber-based dough 1c which is solidified [according to step (d)] to result in the potato-based cheese analogue 1d.

FIG. 2 depicts an embodiment of the method in accordance with the invention comprising providing intact washed raw potato tubers 2a, slicing the intact washed raw potato tubers resulting in sliced raw potato tubers 2b, cooking the sliced raw potato tubers resulting in cooked potato tuber material comprising all ingredients of the potato tuber 2c, providing the cooked potato tuber material 2c comprising all ingredients of the potato tuber [according to step (a)], optionally in combination with cooked and dehydrated potato mass 2c′, such as potato flakes and/or granules, subjecting the cooked potato tuber material (2c and optionally 2c′) to high-shear refining treatment [according to step (b)] resulting in a refined potato-tuber-based material 2d, which is subjected to a cooling step under mixing conditions [according to step (c)] resulting in a potato-tuber-based dough 2e which is solidified [according to step (d)] to result in the potato-based cheese analogue 2f.

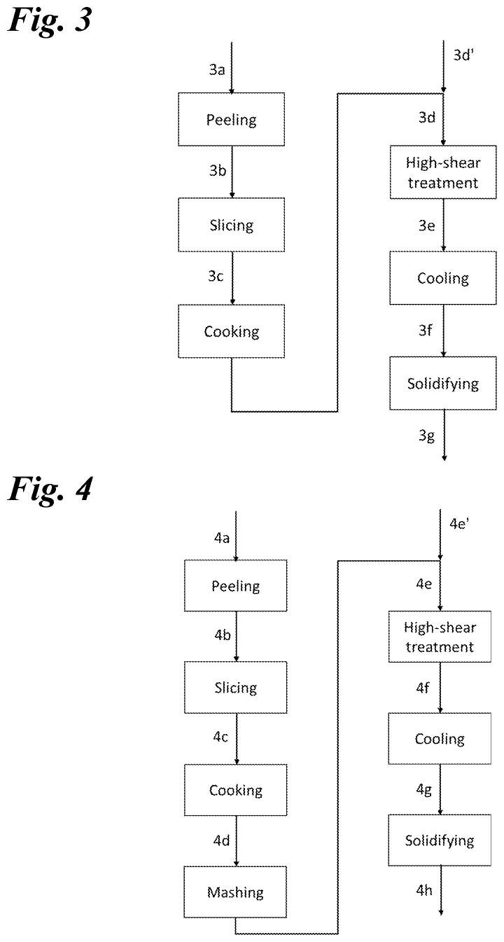

FIG. 3 depicts an embodiment of the method in accordance with the invention comprising providing intact washed raw potato tubers 3a, peeling the intact washed raw potato tubers resulting in peeled raw potato tubers 3b, slicing the peeled raw potato tubers resulting in peeled and sliced raw potato tubers 3c, cooking the peeled and sliced raw potato tubers resulting in cooked potato tuber material comprising all ingredients of potato tuber excluding the skin 3d, providing the cooked potato tuber material comprising all ingredients of potato tuber excluding the skin 3d [according to step (a)], optionally in combination with cooked and dehydrated potato mass 3d′, such as potato flakes and/or granules, subjecting the cooked potato tuber material (3d and optionally 3d′) to a high-shear refining treatment [according to step (b)], resulting in a refined potato-tuber-based material 3e, which is subjected to a cooling step under mixing conditions [according to step (c)] resulting in a potato-tuber-based dough 3f which is solidified [according to step (d)] to result in the potato-based cheese analogue 3g.

FIG. 4 depicts an embodiment of the method in accordance with the invention comprising providing intact washed raw potato tubers 4a, peeling the intact washed raw potato tubers resulting in peeled raw potato tubers 4b, slicing the peeled raw potato tubers resulting in peeled and sliced raw potato tubers 4c, cooking the peeled and sliced raw potato tubers resulting in cooked potato tuber material comprising all ingredients of potato tuber excluding the skin 4d, mashing the cooked potato tuber material resulting in cooked and mashed potato tuber material 4e, providing the cooked and mashed potato tuber material comprising all ingredients of potato tuber excluding the skin 4e [according to step (a)], optionally in combination with cooked and dehydrated potato mass 4e′, such as potato flakes and/or granules, subjecting the cooked and mashed whole potato tuber material (4e and optionally 4e′) to a high-shear refining treatment [according to step (b)], resulting in a refined potato-tuber-based material 4f, which is subjected to a cooling step under mixing conditions [according to step (c)] resulting in a potato-tuber-based dough 4g which is solidified [according to step (d)] to result in the potato-based cheese analogue 4h.

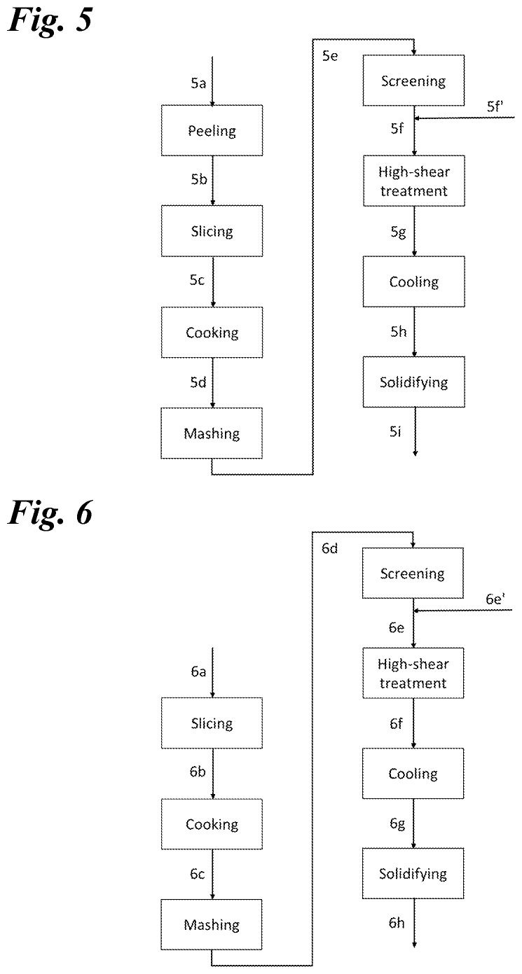

FIG. 5 depicts an embodiment of the method in accordance with the invention comprising providing intact washed raw potato tubers 5a, peeling the intact washed raw potato tubers resulting in peeled raw potato tubers 5b, slicing the peeled raw potato tubers resulting in peeled and sliced raw potato tubers 5c, cooking the peeled and sliced raw potato tubers resulting in cooked potato tuber material comprising all ingredients of potato tuber excluding the skin 5d, mashing the cooked potato tuber material resulting in cooked and mashed potato tuber material 5e, screening the cooked and mashed potato tuber material 5e resulting in cooked, mashed and screened potato tuber material 5f, providing the cooked, mashed and screened potato tuber material 5f [according to step (a)], optionally in combination with cooked and dehydrated potato mass 5f′, such as potato flakes and/or granules, subjecting the cooked, mashed and screened potato tuber material (5f and optionally 5f′) to a high-shear refining treatment [according to step (b)] resulting in a refined potato-tuber-based material 5g, which is subjected to a cooling step under mixing conditions [according to step (c)] resulting in a potato-tuber-based dough 5h which is solidified [according to step (d)] to result in the potato-based cheese analogue 5i.

FIG. 6 depicts an embodiment of the method in accordance with the invention comprising providing intact washed raw potato tubers 6a, slicing the intact washed raw potato tubers resulting in sliced raw potato tubers 6b, cooking the sliced raw potato tubers resulting in cooked potato tuber material comprising all ingredients of potato tuber 6c, mashing the cooked potato tuber material resulting in cooked and mashed potato tuber material 6d, screening the cooked and mashed potato tuber material 6d resulting in cooked, mashed and screened potato tuber material 6e, providing the cooked, mashed and screened potato tuber material 6e [according to step (a)], optionally in combination with cooked and dehydrated potato 6e′, such as potato flakes and/or granules, subjecting the cooked, mashed and screened potato tuber material (6e and optionally 6e′) to a high-shear refining treatment [according to step (b)] resulting in refined potato-tuber-based material 6f, which is subjected to a cooling step under mixing conditions [according to step (c)] resulting in a potato dough 6g which is solidified [according to step (d)] to result in the potato-based cheese analogue 6h.

In step (b), the distance d between the stator and the tips of the rotor is preferably between 1·10⁻⁴ m and 5·10⁻³ m, more preferably between 2·10⁻⁴ m and 6·10⁻⁴ m, such as 4·10⁻⁴ m.

In step (b), v/d in step (b) is preferably higher than 7.2·10⁴ s⁻¹, more preferably higher than 8.0·10⁴, such as 9.6·10⁴ s⁻¹.

The residence time of the cooked potato tuber material between the stator and the tips of the rotor in the high-shear refining treatment of step (b) is preferably at least 5 ms (0.005 s), more preferably at least 10 ms, even more preferably at least 20 ms, such as at least 30 ms, at least 40 ms, at least 50 ms, at least 75 ms, at least 100 ms, at least 250 ms or at least 500 ms.

Step (c) is preferably performed using a cooling device chosen from the group consisting of cooling screw conveyors, scraped surface heat exchangers and rotating cooling drums. Most preferably, step (c) is performed using a scraped surface heat exchanger.

In step (c), the refined potato-tuber-based material is preferably cooled, under mixing conditions, to a temperature of 10° C. or less, more preferably to a temperature of 5° C. or less, even more preferably to a temperature of 4° C. or less.

In a preferred embodiment, step (d) comprises little to no stirring or agitation. In a preferred embodiment, step (d) does not comprise any active heating or cooling. In a preferred embodiment, step (d) comprises storing the potato-tuber-based dough obtained in step (c) at a temperature of less than 12° C., preferably less than 6° C., more preferably less than 5° C., most preferably about 4° C., for more than 12 hours, preferably more than 24 hours, more preferably more than 48 hours, even more preferably more than one week, such as two weeks, without substantially agitating the potato product. The term ‘without substantially agitating’ means that the potato dough is not actively stirred or shaken, although the skilled person will understand that during transport, e.g. from a manufacturing site to a storage facility, mild agitation can occur.

The present inventors have found that it is advantageous to pack the potato-tuber-based dough before solidification step (d) because this allows easy manipulation and is advantageous with regard to microbial stability. Hence, in a preferred embodiment, the potato-tuber-based dough obtained in step (c) is packaged, preferably vacuum packaged, before step (d). In embodiments the potato dough is packaged in batches of more than 1 kg, preferably more than 5 kg.

In a preferred embodiment, v/d in step (b) of the method is higher than 7.2·10⁴ s⁻¹ and the potato-based cheese analogue obtained in step (d) has:
a hardness at 20° C., as determined with a texture analyzer on a sample with a size of 3.5×3.5×4 cm (l×w×h) by performing a 20 mm compression at a speed of 1 mm/s with a 30 kg load cell and a 30 g trigger force, characterized by a Peak Positive Force of at least 7 kg, more preferably of at least 8 kg, and by a Positive Area of at least 75 kg·s; and
a viscosity at 80° C. and at a shear rate of 1 s⁻¹, as measured with a rheometer with a starch cell geometry, of less than 360 Pa·s, and preferably of at least 100 Pa·s, more preferably of at least 125 Pa·s, even more preferably of at least 150 Pa·s.

In another preferred embodiment, the intact washed raw potato tubers provided in step (i) Novano have an underwater weight of between 400 and 490 g, they are preferably chosen from Solanum tuberosum, varieties Fontane and Novano, and the potato-based cheese analogue obtained in step (d) has:
a hardness at 20° C., as determined with a texture analyzer on a sample with a size of 3.5×3.5×4 cm (l×w×h) by performing a 20 mm compression at a speed of 1 mm/s with a 30 kg load cell and a 30 g trigger force, characterized by a Peak Positive Force of at least 13 kg and by a Positive Area of at least 140 kg·s, more preferably of at least 150 kg·s; and
a viscosity at 80° C. and at a shear rate of 1 s⁻¹, as measured with a rheometer with a starch cell geometry, of less than 400 Pa·s, and preferably of at least 100 Pa·s, more preferably of at least 125 Pa·s, even more preferably of at least 150 Pa·s.

In another preferred embodiment, v/d in step (b) of the method is higher than 7.2·10⁴ s⁻¹, the intact washed raw potato tubers provided in step (i) Novano have an underwater weight of between 420 and 490 g, they are preferably chosen from Solanum tuberosum, varieties Fontane and Novano, and the potato-based cheese analogue obtained in step (d) has:
a hardness at 20° C., as determined with a texture analyzer on a sample with a size of 3.5×3.5×4 cm (l×w×h) by performing a 20 mm compression at a speed of 1 mm/s with a 30 kg load cell and a 30 g trigger force, characterized by a Peak Positive Force of at least 14 kg and by a Positive Area of at least 150 kg·s, more preferably of at least 155 kg·s; and
a viscosity at 80° C. and at a shear rate of 1 s⁻¹, as measured with a rheometer with a starch cell geometry, of less than 360 Pa·s, and preferably of at least 100 Pa·s, more preferably of at least 125 Pa·s, even more preferably of at least 150 Pa·s, yet more preferably of at least 200 Pa·s.

In yet another preferred embodiment, v/din step (b) of the method is higher than 8.0·10⁴ s⁻¹, the intact washed raw potato tubers provided in step (i) Novano have an underwater weight of between 420 and 490 g, they are preferably chosen from Solanum tuberosum, varieties Fontane and Novano, and the potato-based cheese analogue obtained in step (d) has:
a hardness at 20° C., as determined with a texture analyzer on a sample with a size of 3.5×3.5×4 cm (l×w×h) by performing a 20 mm compression at a speed of 1 mm/s with a 30 kg load cell and a 30 g trigger force, characterized by a Peak Positive Force of at least 14 kg and by a Positive Area of at least 160 kg·s; and
a viscosity at 80° C. and at a shear rate of 1 s⁻¹, as measured with a rheometer with a starch cell geometry, of less than 350 Pa·s, and preferably of at least 100 Pa·s, more preferably of at least 125 Pa·s, even more preferably of at least 150 Pa·s, yet more preferably of at least 200 Pa·s.

In another aspect, the present invention provides the potato-based cheese analogue obtained by or obtainable by the methods described herein.

In a still further aspect, the present invention provides a meal comprising the potato-based cheese analogue as defined herein or comprising the potato-based cheese analogue obtained or obtainable by the methods as defined herein.

In a preferred embodiment, the meal is a meal which would traditionally comprise cheese, such as commodity cheese. In a preferred embodiment, the meal is chosen from the group consisting of pizza, pasta, lasagna, croque monsieur, meat replacers, bitterballen, cheese soufflé, cheese sticks, cheese burger, gratin, fondue, hot dog, waffle, sandwich, wrap, baked cheese and tortilla chips.

### EXAMPLES

The following analytical protocols were applied in the examples.

### Measurement of the Viscosity

The viscosity of the processed potato products at 80° C. and a shear rate of 1 s⁻¹, i.e. the potato-based cheese analogues as defined herein, is determined as follows:
i) in a first step, 50 g of a sample is first pre-heated in a vacuum sealed bag for 2 minutes and 15 seconds on 360 W (Microwave, Bosch) such that the temperature of the sample reaches about 80° C.;
ii) subsequently, the sealed bag is opened and the sample is immediately poured into the a cup of a starch cell C-ETD 160/ST (Anton Paar GmbH); and
iii) in a third step, the viscosity is measured at 80° C. and at different logarithmically distributed shear rates between 1 s⁻¹ and 100 s⁻¹ using a rheometer with (Anton Paar GmbH, MCIR 302) equipped with a Starch cell C-ETD 160/ST & cup (the cup filled in step (ii)) and a stirrer (geometry ST24-2D/2V/2V-30, Anton Paar GmbH).

A viscosity at 80° C. and 1 s⁻¹ of less than 400 Pa·s is required for a potato-based cheese analogue.

### Measurement of the Hardness

The hardness (or firmness or compressibility) of the processed potato products at 20° C. was determined with a texture analyzer (Stable Micro Systems Ltd, TA-XT Plus), in accordance with the following analytical procedure:
i) in a first step 12 samples of processed potato products were prepared by cutting the processed potato products into cuboids of 3.5×3.5×4 cm (l×w×h);
ii) the samples obtained in step (i) where covered and were allowed to obtain a temperature of 20° C. in a controlled environment;
iii) in a subsequent step the cover was removed from a cuboid sample and said sample was placed on the platform of the texture analyzer;
iv) a compression test was performed at 20° C. by performing a 20 mm compression at a speed of 1 mm/s, a trigger force of 30 g and a load cell of 30 kg;
v) the hardness of the cuboid sample was determined by calculating the Peak Positive Force [kg] and the Positive Area [kg·s] from the data measured in step (iv);
vi) steps (iii) to (v) were repeated for all 12 samples and the values for the Peak Positive Force and the Positive Area were averaged.

The complete settings of the TA-XT Plus texture analyzer were as follows:
Test mode: Compression
Pre-test speed: 1 mm/sec
Test speed: 1 mm/sec
Target mode: Distance
Distance: 20 mm
Trigger force: 30 g
Used Load cell: 30 kg

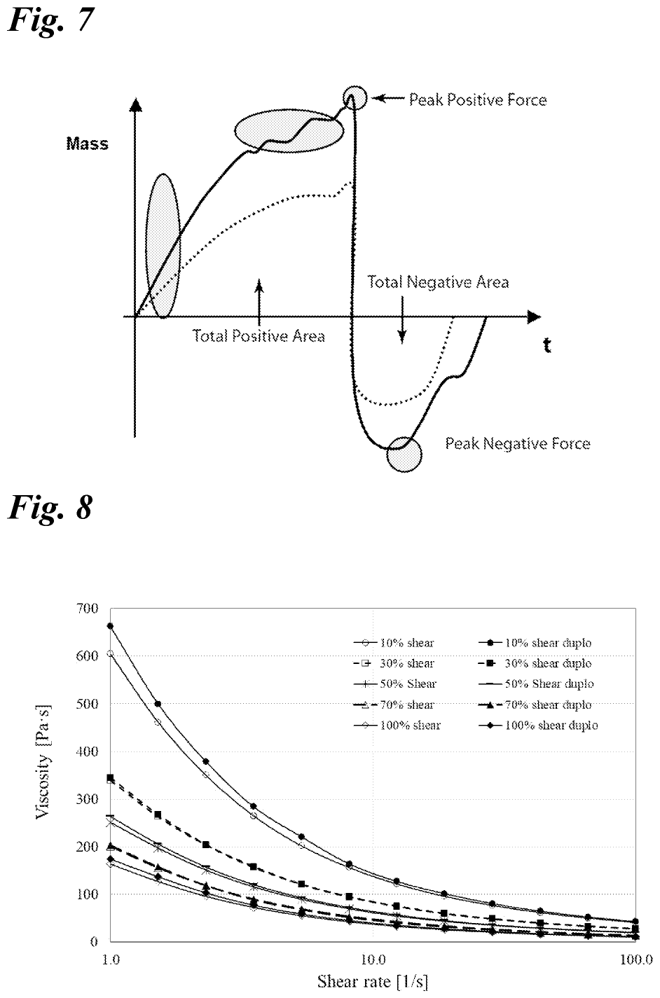

FIG. 7 depicts an example of a load (mass or force) versus time diagram measured with a texture analyzer. In FIG. 7, the Peak Positive Force and the Positive Area [area under the load (mass or force) versus time diagram] are depicted. The vertical axis concerns the increasing mass during compression whereas the horizontal axis concerns the compression time.

A hardness at 20° C. characterized by a Peak Positive Force of at least 6 kg and a Positive Area of at least 75 kg·s is required for a potato-based cheese analogue.

### Example 1

Washed ‘Fontane 440’ potatoes (Solanum tuberosum L., Fontane variety) with an underwater weight of 440 gram were unloaded in a small potato bunker. This potato variety had a dry solids content of 23.6 wt. % and about 17 wt. % of starch, both based on the weight of the raw potato. Below this bunker, an unloading belt was arranged for transporting the potatoes onto a weighing belt. The weighing belt controlled the frequency converter of the bunker unloading belt. Via the weighing belt, 500 kg/h of potatoes were unloaded into a feed screw. The feed screw transported the potatoes to a knife peeler (Sormac, MS-20) to unpeel the potatoes. The drum of the knife peeler was driven by two motors set at a speed of 55%. The peeled potatoes were transported through the knife peeler with a screw conveyor. The peels were washed off with water. About 30% of the potato was peeled off, meaning that about 350 kg/h of potato material was further processed downstream. The peeled potatoes were directly subjected to washing in a washing drum. The peeled and washed potatoes were subsequently transported with a conveying belt to a potato slicer (FAM 7944 slicing machine) wherein the thickness of the sliced potatoes was set to 2 cm.

The potato slices were fed into a steamer (FTNON, single screw) by means of a feed screw. The steam cooker motor was adjustable in speed and was set at 20.3 minutes residence time of the sliced potatoes in the steamer. The steamer was fed with steam and the temperature of the steamer was set to 95° C. After 20.3 minutes at 95° C., the starch in the sliced potatoes was completely gelatinized. At the end of the steam cooker screw, the sliced potatoes fell into a mashing screw (DutchTecSource).

The resulting mashed potato material was screwed into a lobe pump (Pomac PLP 3-3) from where it was transported to a high shear mixer (Daniatech MixMaster 40/250). This high shear mixer had a 22 kW 2 pole motor at 60 Hz and a rotor (open impeller) with a diameter of 204 mm. The gap d between the rotor and the stator was 0.0004 m (0.4 mm). The rotational speed v (in m/s) is the speed of the tips of the rotor. The shear in the high shear mixer is defined as:

$$Shear = v [ m / s ] / d [ m ]$$

The shear applied in the high shear mixer could be varied by changing the speed of the motor, wherein the set point of 100% refers to 60 Hz (corresponding to a shear of 96.1·10³ s⁻¹) and 0% refers to 10 Hz (corresponding to a shear of 16.0·10³ s⁻¹).

The volume of the gap between rotor and the stator was 2.57·10⁻⁶ m³. This resulted in a residence time of the mashed potato material in the high shear area of 55 ms.

The refined potato-tuber-based material was cooled to a temperature of 4° C. under mixing conditions in a Contherm® scraped-surface heat exchanger (Alfa Laval) having a volume of 40 L during a period of 7 minutes.

The cooled refined potato-tuber-based material was collected in 1 liter containers and stored for 2 weeks in a refrigerator at 4-6° C. to obtain potato-based cheese analogues.

In accordance with the above protocol, potato-based cheese analogues were produced with varying amount of shear as defined in the following Table 1.

TABLE 1

| % Shear | Frequency motor [Hz] | Shear [s⁻¹] |
|---|---|---|
| 10 | 15 | 24.0 · 10³ |
| 20 | 20 | 32.0 · 10³ |
| 30 | 25 | 40.1 · 10³ |
| 40 | 30 | 48.1 · 10³ |
| 50 | 35 | 56.1 · 10³ |
| 60 | 40 | 64.1 · 10³ |
| 70 | 45 | 72.1 · 10³ |
| 80 | 50 | 80.1 · 10³ |
| 100 | 60 | 96.1 · 10³ |

Of these potato-based cheese analogues, (a) the viscosity at 80° C. (duplo measurement) and (b) the hardness at 20° C., expressed as the Peak Positive Force and the Positive Area, were determined in accordance with the analytical protocols as defined hereinbefore. The viscosity data are depicted in FIG. 8. The viscosity (averaged) at 80° C. and 1 s⁻¹ or 100 s⁻¹ is further presented in Table 2.

TABLE 2

| % Shear | 10 | 30 | 50 | 70 | 100 |
|---|---|---|---|---|---|
| Viscosity at 1 s⁻¹ [Pa · s] | 634 | 342 | 383 | 202 | 169 |
| Viscosity at 100 s⁻¹ [Pa · s] | 42 | 28 | 30 | 14 | 11 |

The hardness at 20° C., expressed as the Peak Positive Force and the Positive Area, is presented in the following Table 3.

TABLE 3

| % Shear | 10 | 30 | 50 | 70 | 100 |
|---|---|---|---|---|---|
| Peak Positive Force [kg] | 12.1 | 12.5 | 13.0 | 14.0 | 14.9 |
| Positive Area [kg · s] | 135 | 139 | 142 | 159 | 176 |

### Example 2

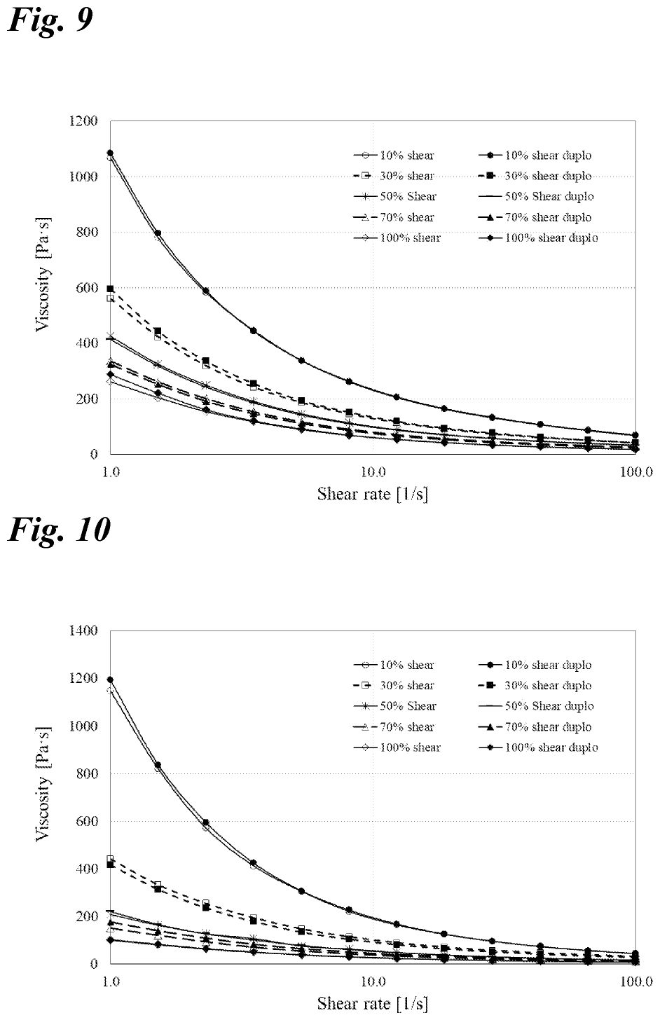

Example 1 was repeated with washed ‘Novano 477’ potatoes (Solanum tuberosum L., Novano variety) with an underwater weight of 477 gram. This potato variety had a dry solids content of 25.4 wt. % and about 18 wt. % of starch, both based on the weight of the raw potato. The viscosity data are depicted in FIG. 9. The viscosity at 80° C. and 1 s⁻¹ or 100 s⁻¹ is further presented in Table 4. The hardness at 20° C., expressed in the Peak Positive Force and the Positive Area, is presented in Table 5.

TABLE 4

| % Shear | 10 | 30 | 50 | 70 | 100 |
|---|---|---|---|---|---|
| Viscosity at 1 s⁻¹ [Pa · s] | 1076 | 579 | 633 | 330 | 275 |
| Viscosity at 100 s⁻¹ [Pa · s] | 69 | 42 | 49 | 26 | 19 |

TABLE 5

| % Shear | 10 | 30 | 50 | 70 | 100 |
|---|---|---|---|---|---|
| Peak Positive Force [kg] | 14.9 | 15.3 | 16.6 | 17.4 | 19.5 |
| Positive Area [kg · s] | 165 | 166 | 178 | 178 | 202 |

### Example 3

Example 1 was repeated with washed Fontane potatoes (Solanum tuberosum L., Fontane variety) with an underwater weight of 390 gram. This potato variety had a dry solids content of 21.2 wt. % and about 15 wt. % of starch, both based on the weight of the raw potato. The viscosity data are depicted in FIG. 10. The viscosity at 80° C. and 1 s⁻¹ or 100 s⁻¹ is further presented in Table 6. The hardness at 20° C., expressed as the Peak Positive Force and the Positive Area, is presented in Table 7.

TABLE 6

| % Shear | 10 | 30 | 50 | 70 | 100 |
|---|---|---|---|---|---|
| Viscosity at 1 s⁻¹ [Pa · s] | 1171 | 428 | 319 | 164 | 101 |
| Viscosity at 100 s⁻¹ [Pa · s] | 44 | 30 | 26 | 13 | 8 |

TABLE 7

| % Shear | 10 | 30 | 50 | 70 | 100 |
|---|---|---|---|---|---|
| Peak Positive Force [kg] | 3.1 | 4.4 | 6.5 | 7.2 | 8.4 |
| Positive Area [kg · s] | 45 | 59 | 77 | 77 | 87 |

### Example 4

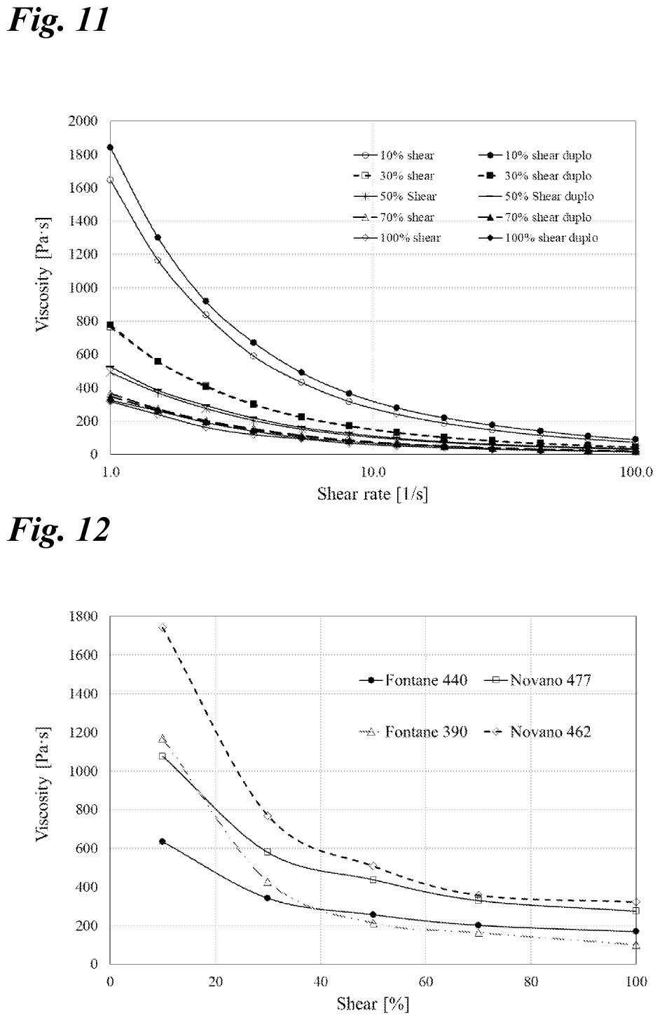

Example 1 was repeated with washed Novano potatoes (Solanum tuberosum L., Novano variety) with an underwater weight of 462 gram. This potato variety had a dry solids content of 24.7 wt. % and about 18 wt,% of starch, both based on the weight of the raw potato. The viscosity data are depicted in FIG. 11. The viscosity at 80° C. and 1 s⁻¹ or 100 s⁻¹ is further presented in Table 8. The hardness at 20° C., expressed as the Peak Positive Force and the Positive Area, is presented in Table 9.

TABLE 8

| % Shear | 10 | 30 | 50 | 70 | 100 |
|---|---|---|---|---|---|
| Viscosity at 1 s⁻¹ [Pa · s] | 1743 | 769 | 754 | 357 | 321 |
| Viscosity at 100 s⁻¹ [Pa · s] | 81 | 44 | 49 | 22 | 17 |

TABLE 9

| % Shear | 10 | 30 | 50 | 70 | 100 |
|---|---|---|---|---|---|
| Peak Positive Force [kg] | 11.2 | 13.1 | 15.8 | 16.8 | 16.3 |
| Positive Area [kg · s] | 132 | 149 | 178 | 180 | 181 |

### Comparative Example 5

Examples 1-4 were repeated without applying mixing during cooling of the refined potato-tuber-based material to a temperature of 4° C. It was concluded that omitting mixing during cooling does not result in the viscosity at 80° C. and 1 s⁻¹ and the hardness at 20° C. that are required for a potato-based cheese analogue.

### Overview Examples 1-4

It is concluded from the data presented in Examples 1-4 (see Tables 2, 4, 6 and 8) that all potato-based cheese analogues show shear-thinning behaviour, meaning that the viscosity decreases when the potato-based cheese analogue is subjected to an increased shear rate. This behaviour is advantageous during the production of the potato-based cheese analogues since it improves the mixing behaviour during cooling the refined potato-tuber-based material.

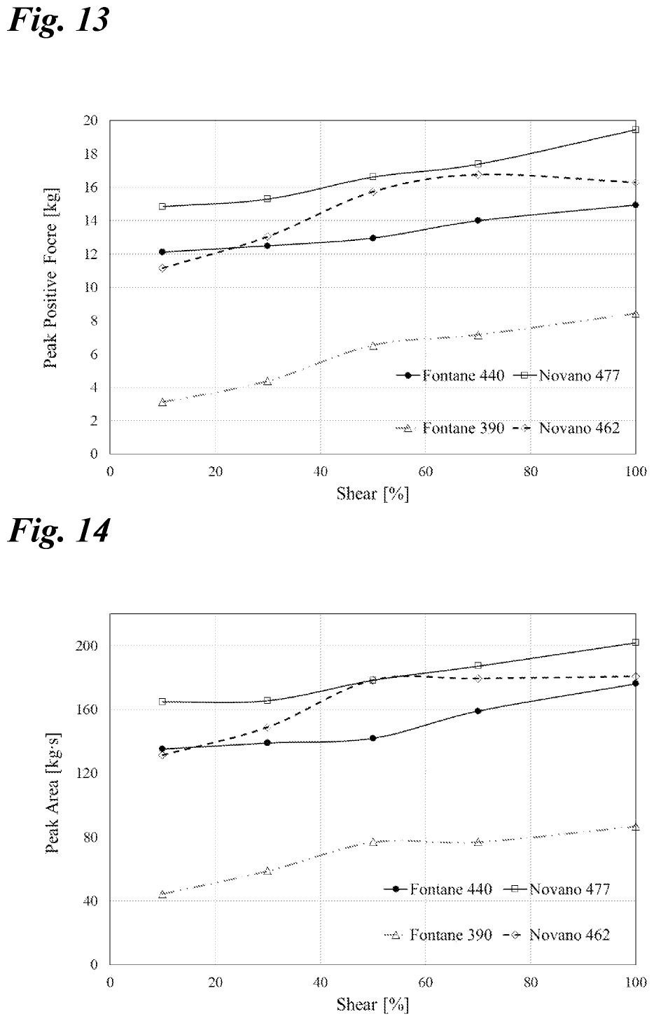

It is further concluded from FIGS. 12-14 that at least 60% shear (see Table 1) is needed to obtain a viscosity at 80° C. and 1 s⁻¹ of less than 400 Pa·s, and a hardness at 20° C. characterized by a Peak Positive Force of at least 6 kg and a Positive Area of at least 75 kg·s.

The potato-based cheese analogues were easily gratable at different grating sizes between 2 to 10 mm. Upon placement in a hot air oven at 200° C. for 5 minutes, the potato-based cheese analogue showed visual melt flow behaviour.

### Example 6

Potato tubers (Solanum tuberosum L., Novano variety) with a dry matter content of 26 wt. % were peeled and washed in a FAMA industrial potato peeler, sliced into slices of 10-15 mm thickness, steam-cooked for 20 minutes in a Philips Avance HD9170 at 100° C. and subjected to high-shear refining for 5 minutes using a Magimix 5200XL auto cuisine system. Next, the potato mass was transferred to a Stephan UMC electronic cooler and cooled from an initial temperature of about 60° C. to 10° C. over a period of about 8 minutes while stirring. Next, the resulting potato dough was vacuum packaged and stored at 4° C. for solidification.

Four different batches were prepared, by adding preservatives in the amounts recited in Table 10 before the high-shear refining step.

TABLE 10

| | | Amount (wt. %, |
|---|---|---|
| | | based on the |
| | | potato-based |
| Batch | Preservative | cheese analogue) |
| 1 | — | — |
| 2 | lactic acid + citric acid | 0.15 + 0.15 |
| 3 | lactic acid + citric acid + | 0.15 + 0.15 + 0.5 |
| | potassium sorbate | |
| 4 | potassium sorbate | 0.5 |

The potato-based cheese analogues were stored at 4° C. for several weeks and the microbiological stability was subsequently evaluated using standard food testing procedures (see Table 11).

TABLE 11

| Batch/ | | | | | | | |
|---|---|---|---|---|---|---|---|
| week | | 0 | 1 | 2 | 3 | 5 | pH |
| 1 | Mesophiles | 8 | 2500 | 4000 | 1.7 | 9.10⁵ | 6.3 |
| | | | | | 10⁵ | | |
| | Yeasts | <2.5 | <2.5 | <2.5 | <2.5 | <2.5 | |
| | Fungi | 1 | 3 | 30 | <2.5 | 2.104 | |
| 2 | Mesophiles | <2.5 | 3 | <2.5 | <2.5 | 5 | 5.1 |
| | Yeasts | <2.5 | <2.5 | <2.5 | <2.5 | <2.5 | |
| | Fungi | <2.5 | <2.5 | <2.5 | <2.5 | <2.5 | |
| 3 | Mesophiles | 3 | <2.5 | <2.5 | <2.5 | <2.5 | 6.3 |
| | Yeasts | <2.5 | <2.5 | <2.5 | <2.5 | <2.5 | |
| | Fungi | <2.5 | <2.5 | <2.5 | <2.5 | <2.5 | |
| 4 | Mesophiles | 5 | <2.5 | <2.5 | <2.5 | 5 | 5.3 |
| | Yeasts | <2.5 | <2.5 | <2.5 | <2.5 | <2.5 | |
| | Fungi | <2.5 | <2.5 | <2.5 | <2.5 | <2.5 | |

### Comparative Example 7

This comparative example was performed in accordance with the process disclosed in AU2014200598A1. 1 kg of washed potato tubers (Solanum tuberosum L., Novano variety) with a dry matter content of 26 wt. % were microwaved using a 1200 W oven for 11 minutes. The reduction in mass by loss of water was 13.2 wt. %. The cooked potatoes were placed in a refrigerator at 3° C. for 24 hours. The potatoes were subsequently sliced in half, peeled and mashed. The mashed potato was heated in a microwave (1200 W) for 2.5 minutes and processed in a blender at 3000 rpm until the potato mass was solid. The potato mass lost another 2.7 wt. % of water. The blended potato mass was solid rather than flowing or liquid as observed in the processes of the invention. The potato mass of Comparative Example 7 was cooled in a refrigerator at 3° C. for 12 hours.

The potato-based cheese was gratable at different grating rates between 2 and 10 mm.

This comparative example demonstrates that the potato-based cheese obtained with this method is not in accordance with the present invention.

### Comparative Example 8

The same procedure was followed as in Comparative Example 7 with the exception that the loss of water was compensated by addition of water before the blending of the potato mass. The potato mass was less solid than the mass of Comparative Example 7, but still solid and not fluid.

The cooled potato-based cheese was gratable at different grating rates between 2 and 10 mm.

The main difference between the potato-based cheese of the Examples of the invention and both potato-based cheeses of Comparative Examples 7 and 8 is the initial heating and subsequent cooling in a refrigerator. This generally leads to retrogradation of the amylose present in the potato mass. It is believed that this considerable retrogradation leads to a more solid potato-based cheese as is observed in Comparative Examples 7 and 8.

1. A potato-based cheese analogue consisting of a mixture of 100 parts (by weight) of a composition (A) and 0-10 parts (by weight) of a composition (B):
wherein composition (A) consists of between 20.7 and 30 wt. % of dry matter and between 70 and 79.3 wt. % of water, based on the weight of composition (A), wherein the dry matter is potato-based material,
wherein the dry matter comprises between 3 and 9.6 wt. % of potato tuber cell wall material and potato tuber intercellular substances, based on the weight of the dry matter, and
wherein the dry matter comprises more than 72 wt. % of potato tuber starch, based on the weight of the dry matter;
wherein composition (B) consists of one or more non-potato-based, further ingredients, with the proviso that the one or more non-potato-based further ingredients do not comprise hydrolysed starch, carrot, egg yolk, flour, casein or combinations thereof,
wherein the potato-based cheese analogue has a hardness at 20° C., as determined with a texture analyzer on a sample with a size of 3.5×3.5×4 cm (l×w×h) by performing a 20 mm compression at a speed of 1 mm/s with a 30 kg load cell and a 30 g trigger force, characterized by a Peak Positive Force of at least 6 kg and a Positive Area of at least 75 kg·s, and
wherein the viscosity of the potato-based cheese analogue at 80° C. and at a shear rate of 1 s⁻¹, as measured with a rheometer with a starch cell geometry, is less than 400 Pa·s.

2. Potato-based cheese analogue according to claim 1, wherein the potato tuber starch comprises amylose and amylopectin.

3. Potato-based cheese analogue according to claim 1, wherein the potato tuber cell wall material and potato tuber intercellular substances in composition (A) are non-starch polysaccharides chosen from the group consisting of cellulose, hemicellulose, pentosans and pectic substances.

4. Potato-based cheese analogue according to claim 1, wherein the potato-based material in composition (A) is material obtained from whole potatoes, optionally peeled whole potatoes, that have only been processed by applying heat, shear and/or pressure.

5. Potato-based cheese analogue according to claim 1, wherein the one or more non-potato-based further ingredients are chosen from the group consisting of fats, oils, fatty acids, phospholipids, cholesterol, proteins, minerals, (food grade) colourants, preservatives, salt, flavouring agents, vitamins and seasoning.

6. Potato-based cheese analogue according to a claim 1, wherein the one or more non-potato-based further ingredients do not comprise hydrolysed starch, milk, milk-derived ingredients, casein, carrot, egg yolk, corn starch, flour, yeast or combinations thereof.

7. Potato-based cheese analogue according to claim 1, wherein the one or more non-potato-based further ingredients do not comprise fats, oils, fatty acids, phospholipids and cholesterol.

8. Potato-based cheese analogue according to claim 1, having:
a hardness at 20° C., as determined with a texture analyzer on a sample with a size of 3.5×3.5×4 cm (l×w×h) by performing a 20 mm compression at a speed of 1 mm/s with a 30 kg load cell and a 30 g trigger force, characterized by a Peak Positive Force of at least 7 kg and by a Positive Area of at least 75 kg·s; and
a viscosity at 80° C. and at a shear rate of 1 s⁻¹, as measured with a rheometer with a starch cell geometry, of less than 360 Pa·s.

9. A method for producing a potato-based cheese analogue according to claim 1, comprising the steps of:
a) providing cooked potato tuber material comprising between 70 and 79.3 wt. % of water, based on the weight of the cooked potato tuber material, wherein said cooked potato tuber material is selected from the group consisting of:
cooked potato tuber material comprising all ingredients of potato tuber;
cooked and mashed potato tuber material comprising all ingredients of potato tuber;
peeled and cooked potato tuber material comprising all ingredients of potato tuber excluding the skin;
peeled, cooked and mashed potato tuber material comprising all ingredients of potato tuber excluding the skin;
b) subjecting the cooked potato tuber material of step (a) to a high-shear refining treatment resulting in a refined potato-tuber-based material comprising between 70 and 79.3 wt. % of water, based on the weight of the refined potato-tuber-based material, wherein high-shear refining treatment refers to subjecting the potato-tuber-based material to shear forces in a rotor-stator mixer, wherein the distance between the stator and the tips of the rotor is d [m], wherein the rotational speed of the tips of the rotor is v [m·s⁻¹] and wherein v/d is higher than 6.4·10⁴ s⁻¹;
c) cooling the refined potato-tuber-based material obtained in step (b) to a temperature of 15° C. or less under mixing conditions, to provide a potato-tuber-based dough; and
d) solidifying the potato-tuber-based dough obtained in step (c) to obtain the potato-based cheese analogue,
wherein 0-10 parts (by weight) of one or more of the non-potato-based, further ingredients are added:
to the cooked potato tuber material provided in step (a), before step (b), per 100 parts (by weight) of the cooked potato tuber material provided in step (a); or
to the refined potato-tuber-based material provided in step (b), before and/or during step (c), per 100 parts (by weight) of the cooked potato tuber material provided in step (a); or
partly to the cooked potato tuber material provided in step (a), before step (b), and partly to the refined potato-tuber-based material provided in step (b), before and/or during step (c), per 100 parts (by weight) of the cooked potato tuber material provided in step (a).

10. Method according to claim 9, comprising the following steps prior to step (a):
i) providing intact washed raw potato tubers;
ii) optionally peeling the intact washed raw potato tubers of step (i);
iii) optionally slicing the intact washed raw potato tubers of step (i) or the peeled raw potato tubers of step (ii);
iv) cooking the intact washed raw potato tubers of step (i) or the sliced raw potato tubers of step (iii) to obtain cooked potato tuber material comprising all ingredients of potato tuber, or cooking the washed and peeled raw potato tubers of step (ii) or the washed, peeled and sliced raw potato tubers of step (iii) to obtain peeled and cooked potato tuber material comprising all ingredients of potato tuber excluding the skin;
v) optionally mashing the cooked potato tuber material comprising all ingredients of potato tuber obtained in step (iv) to obtain cooked and mashed potato tuber material comprising all ingredients of potato tuber, or optionally mashing the peeled and cooked potato tuber material comprising all ingredients of potato tuber excluding the skin obtained in step (iv) to obtain cooked and mashed potato tuber material comprising all ingredients of potato tuber excluding the skin; and
vi) if the cooked potato tuber material comprising all ingredients of potato tuber or the cooked potato tuber material comprising all ingredients of potato tuber excluding the skin obtained in step (iv) or (v) comprises an amount of water that is different from between 70 and 79.3 wt. %, based on the total weight of the cooked potato tuber material, adjusting said amount of water to between 70 and 79.3 wt. %.

11. Method according to claim 9, wherein step (c) is performed using a cooling device chosen from the group consisting of cooling screw conveyors scraped surface heat exchangers and rotating cooling drums.

12. The method according to claim 9, wherein step (d) comprises storing the potato-tuber-based dough obtained in step (c) at a temperature of less than 12° C., without substantially agitating the potato-tuber-based dough.

13. (canceled)

14. Meal comprising the potato-based cheese analogue according to claim 1.

15. Meal according to claim 14, chosen from the group consisting of pizza, pasta, lasagna, croque monsieur, meat replacers, bitterballen, cheese soufflé, cheese sticks, cheese burger, gratin, fondue, hot dog, waffle, sandwich, wrap, baked cheese and tortilla chips.

16. The potato-based cheese analogue according to claim 2, wherein the potato tuber starch comprises amylose and amylopectin, in a weight ratio of amylose:amylopectin of 10:90 or higher.
